(19) United States
(12) Patent Application Publication
(10) Pub. No.: US 2009/0077620 A1
(43) Pub. Date: Mar. 19, 2009

(54) Method and System for Location-Based Wireless Network

(76) Inventors: Ranjith Chirakkoly RAVI, San Jose, CA (US); Saurabh Bhargava, San Jose, CA (US); Shilpa Moghe, San Jose, CA (US); Ajay Malik, San Jose, CA (US)

Correspondence Address: Fay Kaplun & Marcin, LLP/ Motorola, 150 Broadway Suite 702, New York, NY, 10038, US

(21) Appl. No.: 12/121,434

(22) Filed: May 15, 2008

Related U.S. Application Data
(60) Provisional application No. 60/938,598, filed on May 17, 2007.

(51) Int. Cl. G06F 21/20; H04W 84/02

(52) U.S. Cl. 726/1; 370/338; 726/4

(57) ABSTRACT

Described are a method and a system for granting and denying network access to a device based on a location of that device. A method includes determining a current location of at least one mobile unit, permitting network access to a wireless network to the mobile unit if a network access policy of the mobile unit is configured to permit network access for the current location, and denying network access to the wireless network to the mobile unit if the network access policy of the mobile unit is configured to restrict network access for the current location. The system includes a processor generating network access policy data for at least one mobile unit, the network access policy data configured to one of permit network access and restrict network access for the at least one mobile unit depending on a location of the at least one mobile unit within an operating environment, a wireless switch providing a wireless network infrastructure, a location determination module calculating a current location of the at least one mobile unit, and a plurality of wireless access points in communication with the wireless switch, wherein each one of the wireless access points one of permits network access and restricts network access to the at least one mobile unit based on the current location and the network access policy data for the at least one mobile unit.

### PRIORITY CLAIM

This application claims the priority to U.S. Provisional Application Ser. No. 60/938,598, entitled “Method and System for Location-Based Wireless Network,” filed May 17, 2007. The specification of the above-identified application is incorporated herein by reference.

### FIELD OF THE INVENTION

The present invention relates generally to a system and method for granting and denying network access to a device based on a location of that device. Specifically, when a mobile unit is disposed in a particular location, the mobile unit is granted a predetermined set of privileges.

### BACKGROUND INFORMATION

Wireless networking is an inexpensive technology that connects multiple users within a wireless coverage area of a network and provides connections to other networks, such as the World Wide Web. An exemplary wireless network may be a wireless local area network (“WLAN”) for providing radio communication between several devices using at least one wireless protocol, such as those of the 802.1x standards. A wireless local area network may use radio frequency (“RF”) communication channels to communicate between multiple mobile units (“MUs”) and multiple stationary access points. The access points or access ports (both may be referred to herein as “APs”) of the WLAN may be positioned in various location of the environment to prevent any wireless coverage gaps.

In order to standardize the communications over a WLAN, the MUs may be equipped with the wireless fidelity (“wi-fi”) capabilities of the various 802.11x standards (i.e., 802.11a, 802.11b, 802.11g, etc.). The 802.11 standards are a set of wi-fi standards established by the Institute of Electrical and Electronics Engineers (“IEEE”) in order to govern systems for wireless networking transmissions.

An enterprise may deploy a WLAN in order to provide wireless coverage throughout an operating environment. A WLAN is cost efficient, and provides flexible installation and scalability. Furthermore, an operating environment having a limited wired infrastructure may easily be converted into WLAN, offering mobility to compatible wireless devices throughout the environment. However, while WLAN architectures may provide several units with network connectivity, issues such as access control and network security may compromise the privacy and safety of the data and/or users of the network. Since the signal transmitted by the AP may be intercepted by unknown and/or unauthorized MUs, these unauthorized MUs may be granted unauthorized access to the WLAN.

### SUMMARY OF THE INVENTION

The present invention relates to a method and a system for granting and denying network access to a device based on a location of that device. A method includes determining a current location of at least one mobile unit, permitting network access to a wireless network to the mobile unit if a network access policy of the mobile unit is configured to permit network access for the current location, and denying network access to the wireless network to the mobile unit if the network access policy of the mobile unit is configured to restrict network access for the current location. The system includes a processor generating network access policy data for at least one mobile unit, the network access policy data configured to one of permit network access and restrict network access for the at least one mobile unit depending on a location of the at least one mobile unit within an operating environment, a wireless switch providing a wireless network infrastructure, a location determination module calculating a current location of the at least one mobile unit, and a plurality of wireless access points in communication with the wireless switch, wherein each one of the wireless access points one of permits network access and restricts network access to the at least one mobile unit based on the current location and the network access policy data for the at least one mobile unit.

### BRIEF DESCRIPTION OF THE DRAWINGS

FIG. 1 shows an exemplary system for providing a mobile unit with location-based access to a wireless network according to the exemplary embodiments of the present invention.

FIG. 2 shows an exemplary method for providing a mobile unit with location-based access to a wireless network according to the exemplary embodiments of the present invention.

FIG. 3 shows an exemplary processor in communication with a database according to the exemplary embodiments of the present invention.

FIG. 4 shows an exemplary system for providing selective network access to mobile units having different access policies according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used for providing mobile communication devices, or mobile units, with location-based access to a network within an operating environment. Specifically, the present invention is related to systems and methods for selectively restricting and permitting network access to different mobile units within a wireless communication architecture.

In the operating environment, components such as a radio frequency (“RF”) network switch determine a location for each of the mobile units. Thus, the exemplary embodiments of the present invention use wireless networking technology with location determination capabilities to enable location-based security and service to mobile units. Furthermore, the present invention improves the utility of wireless Access Points (“APs”) within a wireless network while reducing the overhead required for deploying and maintaining separate security measures within the wireless network. Those skilled in the art will understand that the term “AP” is exemplary of the present invention and refers to Access Ports or any other device that is capable of receiving and transmitting wireless signals within a network in accordance with the principles and functionality described herein.

An exemplary embodiment of the present invention may be deployed within a large establishment, or operating environment, such as a department store, a mall, a warehouse, a storage lot, a home, etc. The establishment may maintain a wireless local area network (“WLAN”) that provides continuous wireless coverage throughout multiple areas of the establishment. Wireless mobile units may thus be deployed within this coverage to integrate a wireless communications system within the WLAN of the establishment. Advantageously, the WLAN may be set up within an establishment in an unobtrusive and inexpensive manner. Specifically, the APs may be placed in strategic locations in order to precisely calculate the location of the mobile units based on signals received from the mobile units. Furthermore, the elimination of wires allows for the components of the WLAN infrastructure to be placed in various locations and easily repositioned throughout the coverage area.

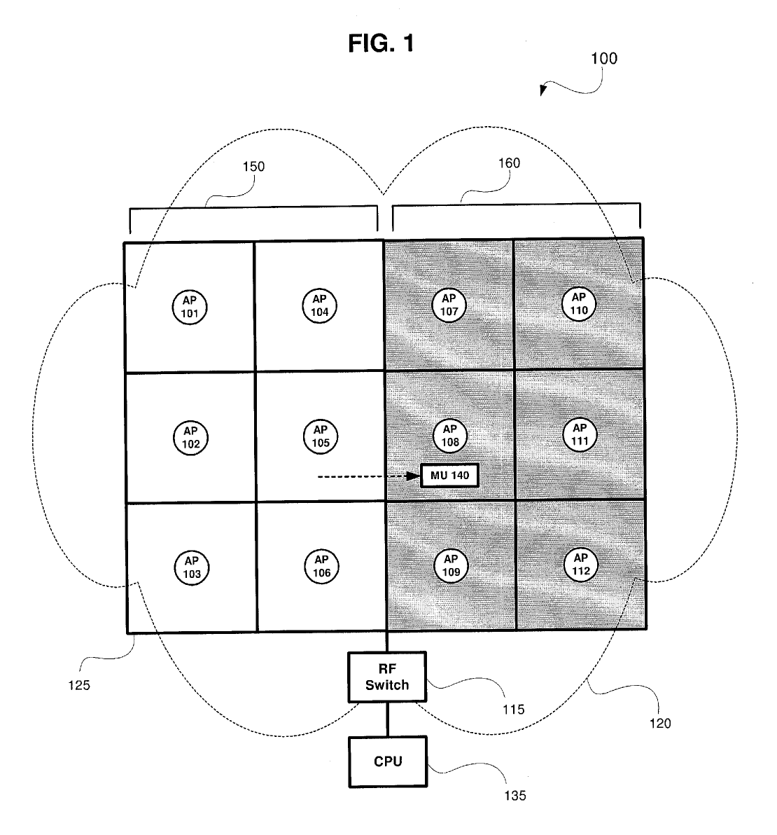

FIG. 1 shows an exemplary system 100 for providing a mobile unit with location-dependent access to a wireless network (e.g., WLAN 120) according to the present invention. The WLAN is implemented within an operating environment 125 having a wireless switch 115 (e.g., a RF switch) and a processor 135 for providing control data throughout the system 100. The WLAN 120 allows multiple wireless devices, such as APs 101-112, to communicate with the wireless switch 115 via radio waves. The plurality of APs 101-112 of the WLAN may be strategically positioned throughout the environment 105 to eliminate any gaps in wireless coverage. Those skilled in the art will understand that the system 100 is only exemplary and that the present invention may be applied to any type of wireless network topology.

The exemplary WLAN 120 may provide radio communication between several devices using at least one wireless protocol, such as those of the 802.1x standards. Specifically, the WLAN 120 may use radio frequency (“RF”) communication channels to communicate between at least one mobile unit, such as MU 140, and the APs 101-112. Further exemplary wireless networks include, but are not limited to, a wireless wide area network (“WWAN”), a wireless personal area network (“WPAN”), etc. In addition, exemplary embodiments of the present invention may be deployed in an operating environment 125 utilizing a private wireless network, such as a virtual private network (“VPN”) of a business enterprise.

The exemplary MU 140 may be any mobile computing device capable of accessing the WLAN 120, such as a portable barcode scanner, a personal digital assistant (“PDA”), a cellular telephone, a Voice over Internet Protocol (“VoIP”) enabled telephone, a laptop, a handheld computer, an image scanner (i.e., photo capturing device), a radio frequency identification (“RFID”) tracking device, a location awareness device (i.e., a real-time location system (“RTLS”)), a global positioning system (“GPS”) device, etc. Those of skill in the art would further understand that the MU 140 may include a non-mobile computing device attached to a wireless device (e.g., a desktop computer with a network interface card).

As described above, each of the APs 101-112 may be strategically positioned throughout the operating environment 125 in order to allow for precise location-determination of MUs within range. For example, each of the APs 101-112 may have a variety of coverage ranges based on the design of the operating environment 125 and the needs of a business enterprise. Furthermore, the placement of the APs 101-112 may allow the operating environment to be divided into operating zones. The use of operating zones will be described in greater detail below. It is important to note that while FIG. 1 illustrates the use of 12 APs in the operating environment 125, those skilled in the art would understand that any number of APs may be employed within the exemplary system 100 while remaining within the scope of the present invention.

Depending on the size and design of the operating environment 125, the wireless switch 115 may be strategically placed in a central location of the operating environment 125 in order to provide a sufficient wireless data signal to each of the APs 101-112. Furthermore, the wireless switch 115 may include an onboard location determination module for calculating a current location of each of the MUs 140. Although the location determination module may be integrated into the wireless switch 115, those skilled in the art would understand that the location determination module may be a separate component from the wireless switch 115. The wireless switch 115 may be linked directly to the processor 135 in order to transfer locationing data between the processor 135 and the APs 101-112, thereby connecting each of the components within the WLAN 120. The link between the wireless switch 115 and the processor 135 may be a wired link, a wireless link, or a combined wired/wireless link. Optionally, there may be multiple wireless switches used throughout the operating environment 125 to extend the coverage area for very large areas such as, for example, providing wireless coverage on multiple floors of a building. Range extending devices (not shown) or signal repeating (not shown) devices may also be used to increase the range of the wireless switch 115.

Regardless of the number of wireless switches implemented within the operating environment 125, each of the APs 101-112 may be placed in direct communication with the processor 135. In the example of FIG. 1, the processor 135 and the wireless switch 115 are in direct communication. However, another exemplary arrangement may be where the processor 135 is connected to a communications network in the form of a server or network appliance, and the wireless switch 115 (or wireless switches) communicate with the processor 135 via the communication network. Furthermore, the functions performed by each of the processor 135 and the wireless switch 115 (e.g., communicating with the APs 101-112, determining the location of the MUs 140, etc.) may be accomplished within a single device. As will be described in greater detail below, the processor 135 may also maintain a database detailing each MU 140 within the enterprise, as well as the network access policy for that MU 140. Accordingly, information for each MU 140, such as the access policies and device profiles, may be obtained and alter via the processor 135 by a network administrator.

In addition, the processor 135 may process the MU-locationing data received from the wireless switch 115. The locationing data may include such data as a received signal strength indication (“RSSI”) value from the MU 140. The received RSSI value may indicate the strength of a signal transmitted from the MU 140 to any of the APs 101-112. Thus, each of the APs 101-112, or alternatively, the processor 135, may observe an RSSI value (e.g., measure the signal strength) for the MU 140 through the use of an exemplary wireless network monitoring tool (not shown). For example, an RSSI value of the MU 140 may vary within a range of arbitrary numbers, such as from 0 to 255. Accordingly, an RSSI value of “1” from the MU 140 may indicate the minimum signal strength detectable by the measuring AP, while a value of “0” may indicate no signal available at the measuring AP. In addition, the APs 101-112, or the processor 135, may observe the RSSI values from further MUs throughout the operating environment 125.

It should be noted that while an exemplary embodiment of the present invention may determine the location of the wireless MU 140 through the use of the RSSI values received at the wireless switch 115, alternative embodiments may allow for additional or alternative MU-locationing techniques to be performed. These further MU-locationing techniques may include, but are not limited to, radio frequency identification (“RFID”) tracking, global positioning system (“GPS”) tracking, in addition to, or as an alternative to, trilateration techniques of RSSI provided from each MU to the APs 101-112 and processed by the wireless switch 115.

According to various exemplary embodiments of the present invention, the APs 101-112 throughout the WLAN 120 may be thin-client APs, thick-client APs, or hybrid APs. Those skilled in the art would understand that the thin-client APs depend primarily on the processor 135 for performing the processing activities, and mainly focus on conveying input and output between the MU 140 and the processor 135 and/or the wireless switch 115. Alternatively, a thick-client AP may be defined as a self-contained AP within a network architecture that performs the majority of any data processing operations itself, and does not necessarily rely on the processor 135, and may only pass data for communications and storage to the processor 135. Thus, as opposed to using the processor 135 for data processing, a thick-client AP may process data from the MU 140 without the use of an external processor. A dedicated processor within each of the thick-client APs may be very useful in applications where several APs operate throughout several points of the operating environment 125. Finally, the use of hybrid APs may allow for a mixture of the mentioned AP models. Similar to the thick-client AP, the hybrid AP may process locally while relying on the processor 135 for storage of data. Accordingly, the hybrid AP offers the high performance features of the thick-client AP and the high manageability and flexibility of the thin-client AP.

The present invention allows a business enterprise to implement multiple levels of network access throughout the operating environment 125. Specifically, each of the mobile units 140 within the operating environment 125 may be assigned different security levels for network access, such as administrative network access and user network access. Thus, mobile units 140 having administrative access to the network may be provided with a broader coverage range (e.g., the entire operating environment 125) than the mobile units 140 having user access to the network.

Furthermore, the operating environment 125 may be divided into zones based on the operations and staffing of an exemplary business enterprise. For example, the operating environment 125 may have a storage zone 150, designated for warehousing an inventory of products. The storage zone 150 may include APs 101-106 for providing network access to the WLAN 120 for mobile units within the storage zone 150. In addition, the operating environment 125 may have retail zone 160, designated for selling the products to consumers. The retail zone 160 may include APs 107-112 for providing network access to the WLAN 120 for mobile units within the retail zone 160. Accordingly, for staff members assigned to the storage zone 150, access by their MUs 140 to the WLAN 120 may be restricted while these staff members' MUs 140 are located in the retail zone 160. A similar access restriction may apply for the MUs 140 of retail zone 160 staff members who are located in the storage zone 150. Thus, the exemplary system 100 may prevent unauthorized use of a mobile unit while a staff member is outside a designated operating zone. Furthermore, a manager of the operating environment 125 may be provided with a mobile unit authorized to access the WLAN 120 from both the storage zone 150 and the retail zone 160, in addition to any other zones within the operating environment 125.

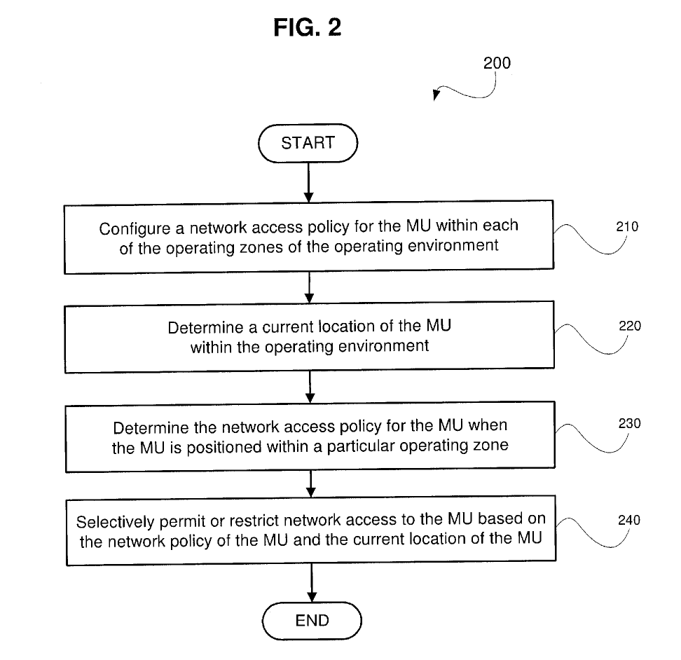

FIG. 2 shows an exemplary method 200 for providing a mobile unit with location-based access to a wireless network according to the present invention. The exemplary method 200 will be described with reference to the exemplary system 100 of FIG. 1. As described above, the operating environment 125 may be a large department store, warehouse, etc. having a wireless network architecture, such as WLAN 120. The operating environment 125 may be divided into a plurality of operating zones, wherein each zone may be designated to a specific operation of the business enterprise. The APs 101-112 may be strategically positioned in various locations throughout the operating environment 125. Accordingly, the positioning of the APs 101-112 may prevent any gaps in the wireless coverage area and may allow for the wireless switch 115 to accurately determine the location of the MUs 140 throughout the operating environment 125. For example, each of the APs 101-112 may provide coverage to a particular operating zone. Alternatively, a group of APs may be assigned to a single operating zone. Regardless of the arrangement of the WLAN 120, each of the APs 110-1112 deployed within the wireless network 100 may transmit information to and from any MUs 140 located within the AP coverage area. In addition, the APs 110-112 may be in wireless communication with a wireless switch 115, wherein the wireless switch 115 may be in direct physical communication with a processor 135.

In step 210, the method 200 may configure a network access policy for the MU 140 within each of the operating zones of the operating environment 125. Specifically, each MU 140 within the operating environment 125 may be assigned with a unique network access policy. The network access policy assigned to each MU 140 may be based on criteria such as the intended operations of the MU 140, the management/administrative level of a user of the MU 140, a user/supervisor operating mode of the MU 140, etc.

In step 220, the method 200 may determine a current location of the MU 140 within the operating environment 125. According to the exemplary embodiment of the present invention, wireless switch 115 may calculate the location of the MU 140 based on a received RSSI value from the MU 140. Specifically, a single AP may be used to calculate a distance to the current location of the MU 140 based on the RSSI value (e.g., locating the MU 140 along a circle around the single AP). A second AP and a third AP may then be used to calculate additional distances to the location of the MU 140 relative to the second and third APs, wherein the MU 140 may be located at the intersection of three circles around each of the first, second, and third APs. Thus, the use of the multiple APs 101-112 allows the wireless switch 115 to precisely determine the operating zone that the MU 140 is currently located.

In step 230, the method 200 may determine the network access policy for the MU 140 when the MU 140 is positioned within the particular operating zone. As described above, each MU 140 may have various network access policies for each operating zone within the operating environment 125. The policy may simply permit or deny network access to the MU 140 while the MU 140 is located within a particular operating zone. In an additional embodiment of the present invention, the network access policy may also alter the type of access available to the MU 140 in any given operating zone. For example, while the MU 140 is located within a first zone, the MU 140 may access the WLAN 120 in a supervisory operating mode. However, once the MU 140 relocates to a second zone, the MU may only access the WLAN 120 in a user operating mode.

In step 240, the method 200 may selectively permit or restrict access to the MU 140 based on the network access policy of the MU 140 and the current location of the MU 140. In other words, the MU 140 is permitted to or restricted from access to the WLAN 120 depending on the policy configured for the MU 140 in the zone of the current location. Thus, the MU 140 may remain associated with the WLAN 120 only when located within the operating zones in which the MU 140 is configured to do so. Once the MU 140 moves to an operating zone where network access is denied, the MU 140 is disassociated from the WLAN 120.

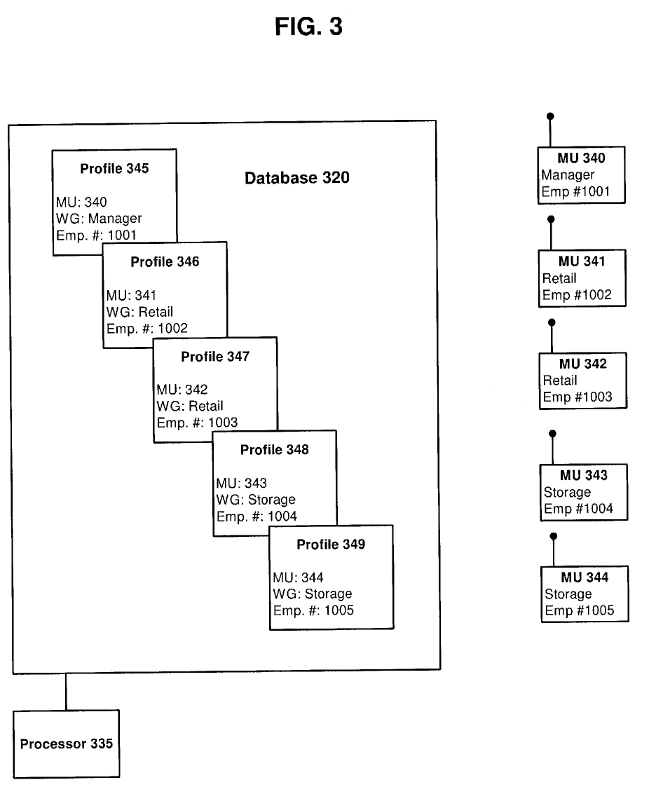

FIG. 3 shows an exemplary processor 335 in communication with a database 320 according to the exemplary embodiments of the present invention. As described above, the processor 335 may allow a network administrator to set and adjust network access policies for the MUs 340-344. Accordingly, the settings for the various network policies may be stored and maintained within the database 320.

According to one exemplary embodiment of the present invention, each of the MUs 340-344 may have corresponding device profiles 345-349. For example, various characteristics for each of the MUs 340-344 may be defined within these device profiles 345-349, such as a network access policy for each of the MUs 340-344. In addition to network access policies, these device profiles 345-349 may also include information such as a current location of the MU, a device or unit number of the MU, a work group or class, an employee name/number, user log-in status, security level clearance for the device and/or the employee, firmware or software version number, battery power, other diagnostic information, etc.

As illustrated in FIG. 3, the unit number contained within the profile 345 may correspond to the MU 340. Accordingly, any relevant information pertaining to the MU 340 may be wirelessly communicated from the MU 340 to the processor 335. This information may be stored within the database 320 and accessed by the network administrator. Furthermore, changes may be applied to the profile 345 via the database 320. For example, the network administrator may modify the network access policy for the MU 340. In addition, the administrator may remotely terminate any access to the network for the MU 340.

According to the embodiment disclosed in FIG. 3, the MU 340 may be assigned to the work group of “manager” from within the database. Alternatively, the MU 340 may be assigned to the manager group upon recognition of log-in information provided by a user of the MU 340. For example, when a manager, e.g., Employee #1001, logs into the MU 340, the profile 345 may display that a manager has logged into the MU 340, as well as information specific to the manager, e.g., the employee number, name, etc. Accordingly, the MU 340 may then be provided with managerial network access based on a managerial access policy. Managerial network access may, for example, allow for complete access throughout each region of the operating environment.

In addition, the MUs 341 and 342 may be assigned to the work group of “retail” or “sale representative” from within the database. Alternatively, the MUs 341 and 342 may be assigned to the retail group upon recognition of log-in information provided by the users of the MUs 341 and 342. For example, when sale representatives, e.g., Employee #1002 and #1003, log into the MUs 341 and 342, the corresponding profiles 346 and 347 may display that the sales representatives has logged into the MUs 341 and 342, as well as additional information, e.g., the employee number, name, etc. Accordingly, the 341 and 342 may then be provided with limited network access based on a retail access policy. The retail access policy may limit a user's access to the network while the MUs 341 and 342 are located within a specific region, such as a retail zone.

Furthermore, the MUs 343 and 344 may be assigned to the work group of “storage” or “stock handler” from within the database. Alternatively, the MUs 343 and 344 may be assigned to the storage group upon recognition of log-in information provided by the users of the MUs 343 and 344. For example, when stock handlers, e.g., Employee #1004 and #1005, log into the MUs 343 and 344, the corresponding profiles 348 and 349 may display that the stock handlers has logged into the MUs 343 and 344, as well as additional information, e.g., the employee number, name, etc. Accordingly, the 343 and 344 may then be provided with limited network access based on a storage access policy. The storage access policy may limit a user's access to the network while the MUs 343 and 344 are located within a specific region, such as a storage zone, warehouse, etc.

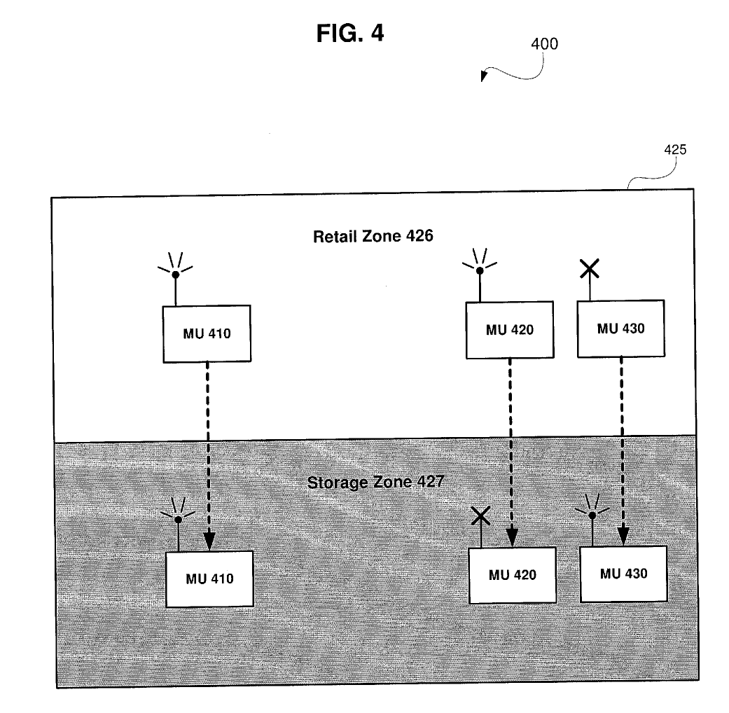

FIG. 4 shows an exemplary system 400 for providing selective network access to MUs 410, 420, 430 within operating environment 425, wherein each of the MUs 410-430 may have different access policies according to the exemplary embodiments of the present invention.

As described above, the operating environment 425 may be divided into a plurality of sub-regions, such as a retail zone 426 and a storage zone 427. Each of the zones 426 and 427 may have one or more APs for providing network coverage within the respective zones. While the operating environments 425 is illustrated as only having two sub-regions, it should be noted that there may be any number of sub-regions.

Depending on the network access policy maintained by MUs 410-430, each MU may be denied or granted access to the network based on the location of the MU. According to the embodiment disclosed in FIG. 4, MU 410 may be assigned to a manager, MU 420 may be assigned to a retail employee, and MU 430 may be assigned to a storage employee.

As described above, the access policy of MU 410 may allow for network access within both the retail zone 426 and the storage zone 427. However, the access policy of MU 420 may only allow for network access when the MU 420 is located within the retail zone 426 and may deny network access when the MU 420 is located anywhere outside of the retail zone 426. Similarly, the access policy of MU 430 may only allow for network access when the MU 430 is located within the storage zone 427 and may deny network access when the MU 430 is located anywhere outside of the retail zone 427. It should be noted that if any of the MUs 410-430 cannot be located (e.g., there is no location data corresponding to the MU), then the MU 410-430 may be deny access to the network.

As illustrated in FIG. 4, each of the MUs 410-430 may be initially located within the retail zone 426 and then subsequently travel to a new location, namely storage zone 427. As the managerial MU 410 changes locations, the manager access policy permits the MU 410 may remain connected to the network. As the retail MU 420 changes location (i.e., exits the retail zone 426), the retail access policy may disconnect the MU 420 from the network. As the storage MU 430 changes location (i.e., enters the storage zone 427), the storage access policy may connect the MU 430 to the network.

It should be noted that while the embodiment described in FIG. 4 includes three separate access policies for the MUs 410-420, any number of network access policies may be assigned to each of the MUs 410-420. For example, the policies may range from single region access (e.g., access from a single AP), to multiple region access (e.g., access to two or more APs, two or more regions, etc.), to complete access within the operation environment 425 (e.g., access to every AP, access within every region, etc.).

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
determining a current location of at least one mobile unit;
permitting network access to a wireless network to the mobile unit if a network access policy of the mobile unit is configured to permit network access for the current location; and
denying network access to the wireless network to the mobile unit if the network access policy of the mobile unit is configured to restrict network access for the current location.

2. The method of claim 1, further comprising:
configuring the network access policy for the mobile unit, the network access policy one of permitting network access and denying network access to the mobile unit for each of a plurality of locations within an operating environment.

3. The method of claim 1, wherein the current location of the at least one mobile unit is determined based on a received signal strength indication value from the at least one mobile unit.

4. The method of claim 1, further comprising:
receiving data from at least one of the mobile unit; and
storing in a database a plurality of network access policies, wherein each of the network access policies corresponds to at least one mobile unit.

5. The method of claim 4, further comprising:
adjusting at least one of the network access policies stored within the database to change one of a permission to access the network when the mobile unit is located in one of the locations and a denial to access the network when the mobile unit is located in one of the locations.

6. The method of claim 4, wherein the data received from the at least one mobile unit includes at least one of location data and diagnostic data.

7. The method of claim 2, wherein the operating environment is divided into zones based on positions of a plurality of access points within the operating environment, and the location of the at least one mobile unit is determined to be in one of the zones.

8. The method of claim 1, wherein the determining the current location of the at least one mobile unit is accomplished by at least one of radio frequency identification tracking, global positioning system tracking, and a triangulation technique of a signal received from the at least one mobile unit.

9. The method of claim 1, wherein the at least one mobile unit is one of a personal digital assistant (“PDA”), a cell phone, a Voice over Internet Protocol (“VoIP”) phone, a laptop, a handheld computer, a portable barcode scanner, and a non-mobile computing device attached to a network interface card.

10. A system, comprising:
a processor generating network access policy data for at least one mobile unit, the network access policy data configured to one of permit network access and restrict network access for the at least one mobile unit depending on a location of the at least one mobile unit within an operating environment;
a wireless switch providing a wireless network infrastructure;
a location determination module calculating a current location of the at least one mobile unit; and
a plurality of wireless access points in communication with the wireless switch, wherein each one of the wireless access points one of permits network access and restricts network access to the at least one mobile unit based on the current location and the network access policy data for the at least one mobile unit.

11. The system of claim 10, wherein the location determination module is integrated into the wireless switch.

12. The system of claim 10, wherein the current location of the at least one mobile unit is determined based on signal strength received in the wireless access points from the at least one mobile unit.

13. The system of claim 10, further comprising:
a database receiving data from the at least one of a plurality of mobile units, and storing plurality of network access policies, wherein each of the network access policies corresponds to at least one mobile unit.

14. The system of claim 13, wherein at least one of the network access policies stored within the database is adjusted to change one of a permission to access the network when the mobile unit is located in one of the locations and a denial to access the network when the mobile unit is located in one of the locations.

15. The system of claim 13, wherein the data received from the at least one mobile unit includes at least one of location data and diagnostic data.

16. The system of claim 10, wherein the operating environment is divided into zones based on the positions of a plurality of access points within the operating environment, and the location of the at least one mobile unit is determined to be in one of the zones.

17. The system of claim 10, wherein the determining of the current location of the at least one mobile unit is accomplished by at least one of radio frequency identification tracking, global positioning system tracking, and triangulation techniques of a signal received from the at least one mobile unit.

18. A device, comprising:
a processor generating network access policy data for at least one mobile unit, the network access policy data configured to one of permit network access and restrict network access for the at least one mobile unit depending on a location of the at least one mobile unit;
a database receiving data from at least one of a plurality of mobile units, and storing plurality of network access policies, wherein each of the network access policies corresponds to at least one mobile unit; and
an antenna in communication with at least one mobile unit, wherein antenna one of permits network access and restricts network access to the at least one mobile unit based on the current location and the network access policy data for the at least one mobile unit.

19. A system, comprising:
a location determining means for determining a current location of at least one mobile unit;
a network access permitting means for permitting to the mobile unit network access to a wireless network if a network access policy of the mobile unit is configured to permit network access for the current location;
a network access denying means for denying to the mobile unit network access to the wireless network if the network access policy of the mobile unit is configured to restrict network access for the current location; and
a policy configuring means for configuring the network access policy for the mobile unit, the network access policy one of permitting network access and denying network access to the mobile unit for each of a plurality of locations within an operating environment.
